(19) United States
(12) Patent Application Publication
(10) Pub. No.: US 2015/0047672 A1
(43) Pub. Date: Feb. 19, 2015

(54) REMOVABLE TIP ORAL HYGIENE DEVICE

(71) Applicant: Fatimah Giwa, Queens Village, NY (US)

(72) Inventor: Fatimah Giwa, Queens Village, NY (US)

(21) Appl. No.: 13/965,370

(22) Filed: Aug. 13, 2013

(51) Int. Cl. B08B 1/00; A61H 13/00

(52) U.S. Cl. CPC B08B 1/003; A61H 13/00
USPC 134/6; 15/118

(57) ABSTRACT

A removable tip oral hygiene device to clean a plurality of soft surfaces within a user's mouth comprising an elongated body, where the elongated body extends between a first end and a second end; a textured tip at the first end; a removable cleaning material attached to the textured tip, where the removable cleaning material cleans the user's gums; and a textured surface at the second end, where the textured surface cleans a tongue of the user. During use, the removable cleaning material is replaced as needed to gently clean the user's gums.

### BACKGROUND OF THE INVENTION

1. Field of the Invention

The present invention relates to an oral hygiene device with a soft removable tip to massage and clean a user's gums.

2. Description of Related Art

A variety of oral hygiene devices are available on the market to assist a user to clean and disinfect their mouths. Most commonly used items are toothbrushes, floss and mouthwash. The toothbrushes are able to sweep away the debris around all surfaces of the teeth, cheeks and tongue. Floss is able to reach the surfaces between the teeth to clean the interproximal debris. Finally, the mouthwash washes away any residual debris that may be loosened or dislodged after brushing and flossing, and also includes ingredients to kill bacteria in the mouth. After using these three main tools a user's mouth is afforded a fresh clean mouth.

For young children and even infants very soft bristle toothbrushes and low foam toothpaste are available to maintain proper oral hygiene. Additionally, finger covers with soft rubberized bristles are available to clean the soft surfaces of the baby's mouth. The soft rubber gently massages the gums to prevent scraping and cutting in the mouth. Sometimes even these soft rubber or synthetic bristles can be too harsh in the infant's mouth, causing pain and discomfort. This leaves the parent or caregiver with limited options to clean the mouth. Sometimes as a last resort washcloths or even cotton balls may be used to gently wipe the oral cavity.

Therefore, it would be beneficial in the art to provide an oral hygiene device that is very gentile for use in an infant's mouth. It would also be desirable in the art to provide an oral hygiene device that simply and easily cleans all surfaces within the child's mouth.

### SUMMARY OF THE INVENTION

In view of the foregoing disadvantages inherent in the prior art, the general purpose of the present invention is to provide an oral hygiene device with a removable cleaning tip, configured to include all of the advantages of the prior art, and to overcome the drawbacks inherent therein.

Accordingly, an object of the present invention is to provide a removable tip oral hygiene device to easily scrub and clean the soft surfaces of an infant's mouth.

Another object of the present invention is to provide a removable tip oral hygiene device with a second end that scrubs and wipes the surfaces of the user's tongue.

To achieve the above objects, in an aspect of the present invention, a removable tip oral hygiene device is described comprising an elongated body, where the elongated body extends between a first end and a second end; a textured tip at the first end; a removable cleaning material attached to the textured tip, where the removable cleaning material cleans an inside of a user's mouth; and a textured surface at the second end, where the textured surface cleans a tongue of the user. During use, the removable cleaning material is replaced as needed to gently clean the user's gums.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a removable tip oral hygiene device in accordance with an exemplary embodiment of the present invention.

### DETAILED DESCRIPTION OF THE DRAWINGS

The present invention relates to an oral hygiene device with a soft removable tip to massage and clean a user's gums. The present invention provides a removable tip oral hygiene device to prevent users from injuring their gums with standard oral cleaning devices. The removable tip oral hygiene device replaces the bristles on conventional toothbrushes with a soft cotton material which helps to massage, soothe and clean the gums. The handle of the removable tip oral hygiene device is covered in a soft gel material for a comfortable feel in the user's hand. With the removable tip oral hygiene device the user is afforded a gentle cleansing device that will not cut or damage soft or sensitive gums.

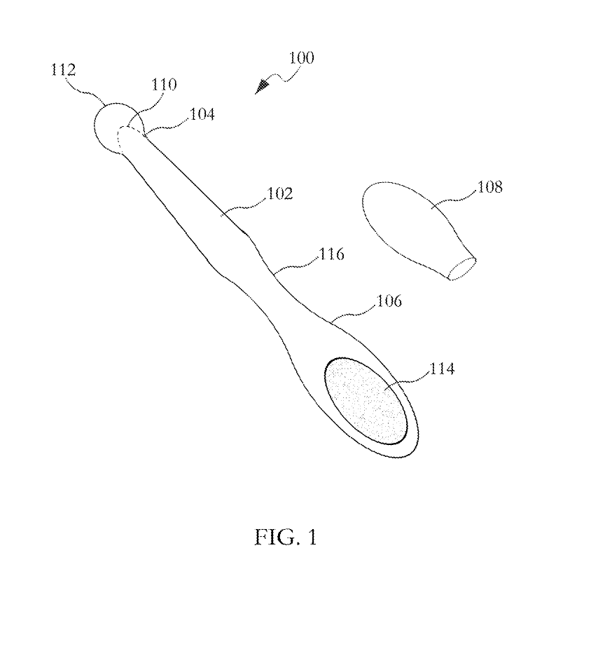

Turning now descriptively to the drawings, referring to FIG. 1, a removable tip oral hygiene device 100 in accordance with an exemplary embodiment of the present invention. The removable tip oral hygiene device 100 includes an elongated body 102 that extends between a first end 104 and a second end 106. The elongated body 102 may be made from plastic and covered in a soft, waterproof material from the first end 104 to the second end 106. The soft, waterproof material may be a silicone gel, rubber, or latex. At a midpoint on the elongated body 102 may be a curved indention 116 which provides a handle for a user to grip the removable tip oral hygiene device 100.

The first end 104 may comprise a rounded shape, and include a textured tip 110 to receive a removable cleaning material 112. The textured tip 110 may be textured like the hook portion of a hook and loop fastener to ensure that the removable cleaning material 112 remains on the textured tip 110. The removable cleaning material 112 may be a cotton ball that catches on the textured tip 110. The removable cleaning material 112 gently scrubs and massages the user's gums without scratching or cutting. After each use the removable cleaning material 112 may be dislodged from the textured tip 110, discarded and then replaced with a new removable cleaning material 112. When not in use, the first end 104 may be placed within a sleeve 108 to protect the underlying textured tip 110 and removable cleaning material 112.

The second end 106 may be rounded with a flat side. The flat side may be covered with a textured surface 114 to clean and scrub a user's tongue. The textured surface 114 may be a rubberized surface for a soft feel against the tongue. With the removable tip oral hygiene device 100 the user is afforded a dual purpose cleaning device that will not scratch or damage the inside of the user's mouth. By utilizing cotton balls as the removable cleaning material 112 the user may easily and repeatedly exchange the material 112 as needed during use. The removable tip oral hygiene device 100 may be used for both infants and adults with missing teeth to gently clean and massage their gums.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A removable tip oral hygiene device for cleaning a plurality of soft surfaces within a user's mouth comprising:
a. an elongated body, where the elongated body extends between a first end and a second end;
b. a textured tip at the first end;
c. a removable cleaning material attached to the textured tip, where the removable cleaning material cleans the user's gums; and
d. a textured surface at the second end, where the textured surface cleans a tongue of the user.

2. The removable tip oral hygiene device according to claim 1, where the elongated body is covered in a soft, waterproof material.

3. The removable tip oral hygiene device according to claim 2, where the soft material is one of at least silicone gel, rubber or latex.

4. The removable tip oral hygiene device according to claim 1, where the elongated body includes a curved intention to serve as a handle for the user.

5. The removable tip oral hygiene device according to claim 1, where the removable cleaning material is a cotton ball.

6. The removable tip oral hygiene device according to claim 1, where the first end is covered with a sleeve.

7. A method of use for a removable tip oral hygiene device comprising the steps of:
a. applying a removable cleaning material to a textured tip of a first end of an elongated body;
b. massaging an inside of a user's mouth with the removable cleaning material;
c. dislodging the removable cleaning material from the textured tip after use; and
d. scrubbing a tongue of the user with a textured surface at a second end of the elongated body.

8. The method of use for the removable tip oral hygiene device according to claim 7 further including the step of replacing the removable cleaning material with a new removable cleaning material.

9. The method of use for a removable tip oral hygiene device according to claim 7 further comprising the step of placing a sleeve over the first end when not in use.
